(19) United States
(12) Patent Application Publication
(10) Pub. No.: US 2024/0286474 A1
(43) Pub. Date: Aug. 29, 2024

(54) Frameless Vehicle Door Sealing Strip Structure, Vehicle Door And Vehicle

(71) Applicants: Henniges China Sealing Systems Co, Ltd, Beijing (CN); Henniges Automotive Sealing System Tieling Co, Ltd, Tieling (CN); Henniges Taicang Sealing System Co, Ltd, Taicang City (CN)

(72) Inventors: Jinhui Ma, Beijing (CN); Chao Yang, Beijing (CN); Minchun Zhou, Beijing (CN); Jian Gong, Beijing (CN)

(21) Appl. No.: 18/425,504

(22) Filed: Jan. 29, 2024

(30) Foreign Application Priority Data
Jan. 30, 2023 (CN) 202320194964.9

(51) Int. Cl. B60J 10/77; B60J 10/27

(52) U.S. Cl. CPC B60J 10/77; B60J 10/27

(57) ABSTRACT

A frameless vehicle door sealing strip structure is applied to a sealing connection of a glass piece and a cover plate and includes a sealing strip body and a first and second sealing part. The strip body arranged between the glass piece and the cover plate is fixedly connected to a spigot component of the side wall of the cover plate. The first sealing part is arranged on the side, facing the glass piece, of the strip body in a protruding mode and abuts against and is attached to the side, facing the strip body, of the glass piece. The second sealing part is arranged on the side, facing the glass piece, of the strip body in a protruding mode and fills a gap between the glass piece and the cover plate. Two defensive lines for sealing and water retaining are formed through the first and second sealing part.

### CROSS-REFERENCE TO RELATED APPLICATIONS

The present application claims priority to and all the benefits of Chinese Patent Application No. 202320194964.9, filed on Jan. 30, 2023, the entire contents of which are hereby expressly incorporated herein by reference.

### FIELD

The subject application relates to the technical field of automobile body parts manufacturing, and specifically relates to a frameless vehicle door sealing strip structure, a vehicle door and a vehicle.

### BACKGROUND

With the gradual rise of new energy vehicles, the demand for frameless vehicle door sealing strip is increasing. As shown in FIGS. 1 and 2, the traditional frameless vehicle door sealing strip includes a sealing strip body 1 disposed between a glass piece 2 and a cover plate 3. A first sealing part is arranged on a side, facing the glass piece 2, of the sealing strip body 1 in a protruding mode. The first sealing part 11 abuts against and is attached to the glass piece 2. The sealing effect of this traditional frameless vehicle door sealing strip structure is not satisfactory, and as shown in FIG. 1, water can easily enter underneath the glass piece 2 through the edge of the gap between the glass piece 2 and the cover plate 3 via location A. Since there is only the first sealing part 11 to seal underneath the glass piece 2, when the amount of water is large, the water can easily cross the first sealing part 11 underneath the glass piece 2 and enter into the vehicle, causing water leakage.

### SUMMARY

Therefore, the technical problem to be solved by the subject application is to overcome the poor sealing effect of the frameless vehicle door sealing strip structure in the prior art, which leads to the defect that water easily crosses a glass piece and enters into the vehicle when the amount of water is large, causing water leakage. Thus, a frameless vehicle door sealing strip structure, a vehicle door and a vehicle are provided.

According to the first aspect of the subject application, a frameless vehicle door sealing strip structure is provided for sealing connection between a glass piece and a cover plate. The frameless vehicle door sealing strip structure includes: a sealing strip body to be arranged between a glass piece and a cover plate, and the sealing strip body is fixedly connected to a spigot component of the side walls of the cover plate;
a first sealing part is arranged on a side, facing the glass piece, of the sealing strip body in a protruding mode, and the first sealing part abuts against and is attached to a side, facing the sealing strip body, of the glass piece; and
a second sealing part is arranged on a side, facing the glass piece, of the sealing strip body in a protruding mode and used for filling in a gap space between the glass piece and the cover plate.

A frameless vehicle door sealing strip structure according to the subject application has at least the following technical effects: by adding a second sealing part for filling the gap space between the glass piece and the cover plate on a side of the sealing strip body facing the glass piece, compared to the prior art, the first sealing part and the second sealing part in the structure form two defensive lines for sealing and water-blocking, ensuring that even if the added second sealing part fails, the first sealing part will still serve as the second defensive line, thus provide better sealing and waterproofing function, ensuring that even when the amount of water is large, water will not easily enter into the vehicle through the glass piece to form water leakage. At the same time, the gap space between the glass piece and the cover plate is filled through the second sealing part, which can effectively reduce the amount of water entering between the glass piece and the cover plate, thereby effectively avoiding the excessive water amount that causes water to cross the glass piece and enter into the vehicle and form water leakage.

Preferably, a third sealing part is arranged on a side, facing the glass piece, of the sealing strip body in a protruding mode, and the third sealing part is located between the first sealing part and the second sealing part. The third sealing part abuts against and is attached to the side, facing the sealing strip body, of the glass piece.

Preferably, a portion of the sealing strip body located between the third sealing part and the second sealing part is set as a first arc segment, and the second sealing part, the first arc segment and the third sealing part surround to form a first water guide groove.

Preferably, a portion of the sealing strip body located between the first sealing part and the third sealing part is set as a second arc segment, and the first sealing part, the second arc segment and the third sealing part surround to form a second water guide groove.

Preferably, the third sealing part is configured as a third sealing lip distributed in a trend of gradually away from the center of the circle in the circumferential direction.

Preferably, the second sealing part includes an arc surface distributed in a trend of gradually approaching the center of the circle in the circumferential direction, and the arc surface abuts against and is attached to the side of the glass piece facing the cover plate.

Preferably, the first sealing part is configured as a first sealing lip distributed in a trend of gradually away from the center of the circle in the circumferential direction.

Preferably, a side of the sealing strip body facing away from the glass piece is provided with an L-shaped hooking part, and the L-shaped hooking part is provided with an installation groove for the side walls of the cover plate to be embedded; a portion of the L-shaped hooking part parallel to the glass piece is provided a plurality of deformable first latching teeth on a side of the portion facing the glass piece, and the first latching teeth are used to snap into the first latching holes of the side walls of the cover plate.

According to a second aspect of the subject application, a vehicle door is provided, which includes a glass piece, a cover plate and a frameless vehicle door sealing strip structure. The frameless vehicle door sealing strip structure is disposed between the glass piece and the cover plate. The frameless vehicle door sealing strip structure adopts the frameless vehicle door sealing strip structure provided according to the above first aspect.

A vehicle door according to the subject application has at least the following technical effects:
by adding a second sealing part for filling the gap space between the glass piece and the cover plate on a side of the sealing strip body facing the glass piece, compared to the prior art, the first sealing part and the second sealing part in the structure form two defensive lines for sealing and water-blocking, ensuring that even if the added second sealing part fails, the first sealing part will still serve as the second defensive line, thus provide better sealing and waterproofing function, ensuring that even when the amount of water is large, water will not easily enter into the vehicle through the glass piece to form water leakage. At the same time, the gap space between the glass piece and the cover plate is filled through the second sealing part, which can effectively reduce the amount of water entering between the glass piece and the cover plate, thereby effectively avoiding the excessive water amount that causes water to cross the glass piece and enter into the vehicle and form water leakage.

A vehicle provided according to a third aspect of the subject application includes the frameless vehicle door sealing strip structure provided according to the above first aspect.

A vehicle according to the subject application has at least the following technical effects:
by adding a second sealing part for filling the gap space between the glass piece and the cover plate on a side of the sealing strip body facing the glass piece, compared to the prior art, the first sealing part and the second sealing part in the structure form two defensive lines for sealing and water-blocking, ensuring that even if the added second sealing part fails, the first sealing part will still serve as the second defensive line, thus provide better sealing and waterproofing function, ensuring that even when the amount of water is large, water will not easily enter into the vehicle through the glass piece to form water leakage. At the same time, the gap space between the glass piece and the cover plate is filled through the second sealing part, which can effectively reduce the amount of water entering between the glass piece and the cover plate, thereby effectively avoiding the excessive water amount that causes water to cross the glass piece and enter into the vehicle and form water leakage.

Additional aspects and advantages of the subject application will be set forth in part in the following description, and in part will be obvious from the description or may be learned by practice of the subject application.

### BRIEF DESCRIPTION OF THE DRAWINGS

In order to describe the specific embodiments of the subject application or technical solution in prior art more clearly, the drawings that need to be used in the description of the specific embodiments or the prior art will be briefly introduced below. Obviously, the drawings described below are only some embodiments of the subject application, and those skilled in the art also can deduce other drawings according to these drawings without inventive step.

FIG. 1 is a schematic structural diagram of an existing frameless vehicle door sealing strip;

FIG. 2 is a schematic rear structural view of the state of the sealing strip body in FIG. 1 not tightly arranged between the glass piece and the cover plate;

FIG. 3 is a schematic structural diagram of a frameless vehicle door sealing strip structure according to an embodiment of the present utility model; and

FIG. 4 is a schematic rear structural view of the state of sealing strip body in FIG. 3 not tightly arranged between the glass piece and the cover plate.

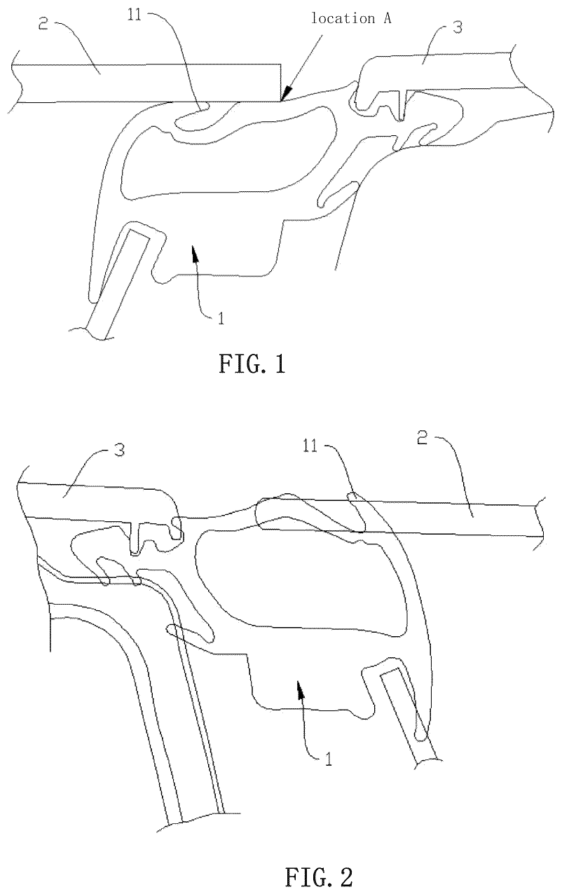

### EXPLANATION OF REFERENCE SYMBOLS

1—a sealing strip body, 11—the first sealing part, 12—the second sealing part, 121—an arc surface, 13—the third sealing part, 14—the first arc segment, 15—the first water guide groove, 16—the second arc segment, 17—the second water guide groove, 18—a L—shaped hooking part, 181—a installation groove, 182—the first latching teeth, 183—a support member, 19—a snap—in portion, 191—a latching groove, 192—the second latching teeth;
2—a glass piece;
3—a cover plate, 31—side walls, 32—a buckle part.

### DETAILED DESCRIPTION

The technical solution of the present utility model will be described clearly and completely below with reference to the accompanying drawings. Obviously, the embodiments described below are only a part of embodiments of the subject application rather than all embodiments of the subject application. Based on the embodiments of the subject application, all of other embodiments obtained by those skilled in the art without inventive step are within the scope sought to be protected by the subject application.

In the description of the subject application, it should be noted that the orientation or positional relationship indicated by terms “center”, “upper”, “lower”, “left”, “right”, “vertical”, “horizontal”, “inner”, “outer”, etc. is based on the orientation or positional relationship shown in the drawings. It is only for the convenience of describing the subject application and simplifying the description rather than indicating or implying that the indicated device or element must have a specific orientation, be constructed and operated in a specific orientation, and therefore cannot be construed as a limitation on the subject application. Furthermore, the terms “first”, “second” and “third” are used for descriptive purposes only and are not to be construed as indicating or implying relative importance.

In the description of the subject application, it should be noted that, unless otherwise clearly stated and limited, the terms “installation”, “communication” and “connection” should be construed in a broad sense. For example, it can be a fixed connection, or a removable connection, or an integrated connection; it can be a mechanical connection or an electrical connection; it can be a direct connection or an indirect connection through an intermediate medium; it can be an internal communication between two components. For those skilled in the art, the specific meanings of the above terms in the subject application can be construed according to specific circumstances.

In addition, the technical features involved in different implementations of the subject application described below can be combined with each other as long as they do not conflict with each other.

### Embodiment 1

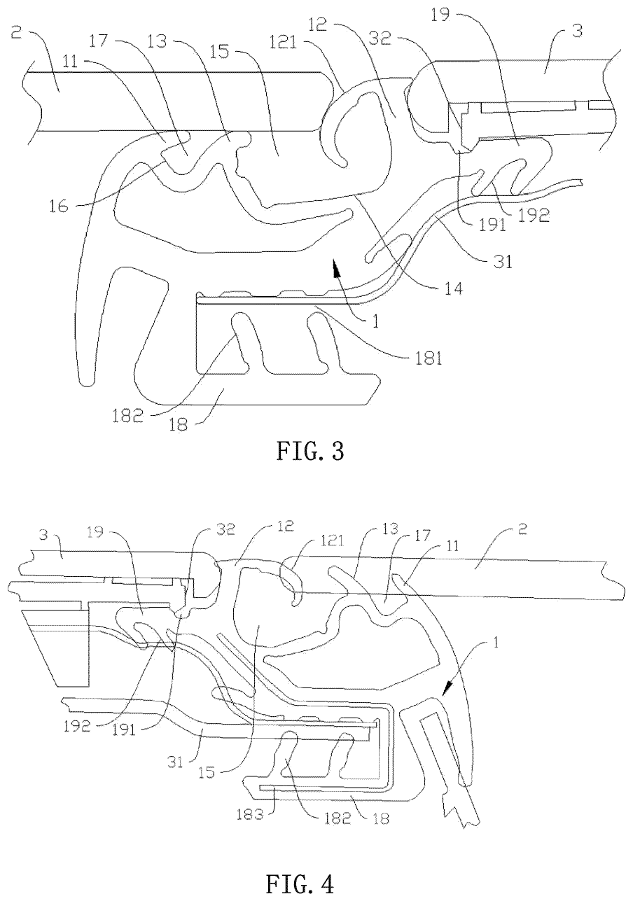

As shown in FIGS. 3 and 4, a frameless vehicle door sealing strip structure provided in this embodiment is used to sealingly connect the glass piece 2 and the cover plate 3. The frameless vehicle door sealing strip structure includes a sealing strip body 1, the first sealing part 11 and the second sealing part 12. The sealing strip body 1 is used to be disposed between the glass piece 2 and the cover plate 3. The sealing strip body 1 is fixedly connected to a spigot component of the side walls 31 of the cover plate 3; the first sealing part 11 is arranged on a side, facing the glass piece 2, of the sealing strip body 1 in a protruding mode, and the first sealing part 11 abuts against and is attached to a side, facing the sealing strip body 1, of the glass piece 2; the second sealing part 12 is arranged on a side, facing the glass piece 2, of the sealing strip body 1 in a protruding mode, and the second sealing part 12 is used for filling in a gap space between the glass piece 2 and the cover plate 3.

In the embodiment of the subject application, by adding a second sealing part 12 for filling the gap space between the glass piece 2 and the cover plate 3 on a side of the sealing strip body 1 facing the glass piece 2, compared to the prior art, the first sealing part 11 and the second sealing part 12 in the structure form two defensive lines for sealing and water-blocking, ensuring that even if the added second sealing part 12 fails, the first sealing part 11 will still serve as the second defensive line, thus provide better sealing and waterproofing function, ensuring that even when the amount of water is large, water will not easily enter into the vehicle through the glass piece 2 to form water leakage. At the same time, the gap space between the glass piece 2 and the cover plate 3 is filled through the second sealing part 12, which can effectively reduce the amount of water entering between the glass piece 2 and the cover plate 3, thereby effectively avoiding the excessive water amount that causes water to cross the glass piece 2 and enter into the vehicle and form water leakage.

As shown in FIG. 3, in some embodiments of the subject application, a third sealing part 13 is arranged on a side, facing the glass piece 2, of the sealing strip body 1 in a protruding mode, and the third sealing part 13 is located between the first sealing part 11 and the second sealing part 12. The third sealing part 13 abuts against and is attached to the side, facing the sealing strip body 1, of the glass piece 2. By adding a third sealing part 13 between the first sealing part 11 and the second sealing part 12, the second sealing part 12, the third sealing part 13 and the first sealing part 11 form three defensive lines for sealing and water-blocking, thus, compared with the existing technology, providing better sealing and waterproofing function, ensuring that even when the amount of water is large, water will not easily enter into the vehicle through the glass piece 2 to form water leakage. Specifically, the first sealing part 11, the second sealing part 12, the third sealing part 13 and the sealing strip body 1 are provided integrally.

Considering that when the rain is heavy, water may enter into the gap between the glass piece 2 and the sealing strip body 1 through a position where the second sealing part 12 and the glass piece 2 abuts against and attaches to each other, and accumulate, causing water leakage in the vehicle; in some embodiments of the subject application, the portion of the sealing strip body 1 between the third sealing part 13 and the second sealing part 12 is configured as a first arc segment 14, and the second sealing part 12, the first arc segment 14 and the third sealing part 13 form a first water guide groove 15; by setting a portion of the sealing strip body 1 located between the third sealing part 13 and the second sealing part 12 as an arc segment to further expand the space of the first water guide groove 15, which not only facilitates the discharge of water that enters the first water guide groove 15 through a position where the second sealing part 12 and the glass piece 2 abuts against and attaches to each other, but also increasing the accumulation capacity of water entering through the position where the second sealing part 12 and the glass piece 2 abuts against and attaches to each other, and can more effectively prevent water from passing through the second defensive line formed by the third sealing part 13, and can play a better sealing and waterproof role.

Considering that the amount of water entering the first water guide groove 15 through a position where the second sealing part 12 and the glass piece 2 abuts against and attaches to each other is so large that the first water guide groove 15 cannot be discharged in time, water may enter into the gap between the glass piece 2 and a portion of the sealing strip body 1 between the first sealing part 11 and the second sealing part 13 through a position where the third sealing part 13 and the glass piece 2 abuts against and attaches to each other, and accumulate, causing water leakage in the vehicle; in some embodiments of the subject application, the portion of the sealing strip body 1 between the first sealing part 11 and the third sealing part 13 is configured as a second arc segment 16, and the first sealing part 11, the second arc segment 16 and the third sealing part 13 form a second water guide groove 17; by setting a portion of the sealing strip body 1 located between the first sealing part 11 and the third sealing part 13 as an arc segment to further expand the space of the second water guide groove 17, which not only facilitates the discharge of water that enters the second water guide groove 17 through the position where the third sealing part 13 and the glass piece 2 abuts against and attaches to each other, but also increasing the accumulation capacity of water entering through the position where the third sealing part 13 and the glass piece 2 abuts against and attaches to each other, and can more effectively prevent water from passing through the third defensive line formed by the first sealing part 11, and can play a better sealing and waterproof role.

In some embodiments of the subject application, the third sealing part 13 is configured as a third sealing lip distributed in a trend of gradually away from the center of the circle in the circumferential direction. The third sealing part 13 arranged in such a shape can further increase the area of abutting against and attaching with the glass piece 2, and can more effectively prevent water flow from passing through the defensive line formed by the third sealing part 13, and can play a better sealing and waterproof role. It should be noted that the trend distribution of gradually away from the center of the circle in the circumferential direction described in this embodiment is based on the perspective shown in FIG. 3.

In some embodiments of the subject application, the second sealing part 12 includes an arc surface 121 distributed in a trend of gradually approaching the center of the circle in the circumferential direction. The arc surface 121 abuts against and is attached to the side, facing the cover plate 3, of the glass piece 2. The arc surface 121 further increases the area abutting against and attaching to the side, facing the cover plate 3, of the glass piece 2, which can more effectively prevent water flow from passing through the defensive line formed by the second sealing part 12, and achieve better sealing and waterproofing effect. It should be noted that the trend distribution of gradually approaching the center of the circle in the circumferential direction described in this embodiment is based on the perspective shown in FIG. 3.

Specifically, the side of the glass piece 2 facing the cover plate 3 is provided with an arc face for tightly fitting the arc surface 121.

In some embodiments of the subject application, the first sealing part 11 is configured as a first sealing lip distributed in a trend of gradually away from the center of the circle in the circumferential direction. The first sealing part 11 arranged in such a shape can further increase the area abutting against and attaching to the glass piece 2, can more effectively prevent water flow from passing through the defensive line formed by the first sealing part 11, and can achieve better sealing and waterproofing effect. It should be noted that the trend distribution of gradually away from the center of the circle in the circumferential direction described in this embodiment is based on the perspective shown in FIG. 3.

As shown in FIGS. 3 and 4, in some embodiments of the subject application, a side of the sealing strip body 1 facing away from the glass piece 2 is provided with an L-shaped hooking part 18, and the L-shaped hooking part 18 is provided with an installation groove 181 for the side walls 31 of the cover plate 3 to be embedded; a portion of the L-shaped hooking part 18 parallel to the glass piece 2 is provided two deformable first latching teeth 182 on a side of the portion facing the glass piece 2, and the first latching teeth 182 are used to snap into the first latching holes of the side walls 31 of the cover plate 3 (not shown in the Figures). The first latching teeth 182 are compressed and deformed to engage with the first latching holes of the side walls 31 of the cover plate 3 to provide a clamping and fixing force, thereby limiting the sealing strip structure of this embodiment to the side walls 31 of the cover plate 3, thereby ensure the stable connection relationship between the sealing strip structure of this embodiment and the cover plate 3 and the glass piece 2. It can be understood that the specific number of the first latching teeth 182 is only optimized here and is not limited. The specific number of the first latching teeth 182 can be adaptively adjusted according to the size of the L-shaped hooking part 18. For example, the number of the first latching teeth 182 may be one, three or five.

As shown in FIG. 4, specifically, the frameless vehicle door sealing strip structure of this embodiment also includes a support member 183. The support member 183 is provided in the sealing strip body 1, and the support member 183 is located between the L-shaped hooking part 18 and the second sealing part 12 to increase the strength of the sealing strip body 1 through the support frame.

In some embodiments of the subject application, the side of the sealing strip body 1 facing away from the glass piece 2 is provided with a snap-in portion 19 parallel to the cover plate 3, and the snap-in portion 19 is provided at one end toward the cover plate 3 a latching groove 191 for the buckle part 32 of the cover plate 3 to engage. The sealing strip structure of this embodiment is fixed on the cover plate 3 by engaging the snap-in portion 19 with the latching groove 191 to provide a fixing force.

Specifically, in order to further improve the tightness of the connection between the sealing strip structure of this embodiment and the cover plate 3, two deformable second latching teeth 192 are provided on a side of the clamping portion 19 away from the cover plate 3, so the second latching teeth 192 are used to lock into the second latching hole (not shown in the Figures) of the side walls 31 of the cover plate 3. The second latching teeth 192 are compressed and deformed to engage with the second latching holes in the side walls 31 of the cover plate 3, and the snap-in portion 19 engages with the latching groove 191, so that the sealing strip structure of this embodiment is stably supported between the cover plate 3 and side walls 31 to prevent prolapse. It can be understood that the specific number of the second latching teeth 192 is only optimized here and is not limited. The specific number of the second latching teeth 192 can be adaptively adjusted according to the size of the sealing strip body 1, for example, the number of the second latching teeth 192 may be one, three or five.

### Embodiment 2

A vehicle door provided in this embodiment includes a glass piece 2, a cover plate 3 and a frameless vehicle door sealing strip structure. The frameless vehicle door sealing strip structure is disposed between the glass piece 2 and the cover plate 3. The frameless vehicle door sealing strip structure adopts the frameless vehicle door sealing strip structure described in Embodiment 1.

In the embodiment of the subject application, by adding a second sealing part 12 for filling the gap space between the glass piece 2 and the cover plate 3 on a side of the sealing strip body 1 facing the glass piece 2, compared to the prior art, the first sealing part 11 and the second sealing part 12 in the structure form two defensive lines for sealing and water-blocking, ensuring that even if the added second sealing part 12 fails, the first sealing part 11 will still serve as the second defensive line, thus provide better sealing and waterproofing function, ensuring that even when the amount of water is large, water will not easily enter into the vehicle through the glass piece 2 to form water leakage. At the same time, the gap space between the glass piece 2 and the cover plate 3 is filled through the second sealing part 12, which can effectively reduce the amount of water entering between the glass piece 2 and the cover plate 3, thereby effectively avoiding the excessive water amount that causes water to cross the glass piece 2 and enter into the vehicle and form water leakage.

### Embodiment 3

A vehicle provided in this embodiment includes the frameless vehicle door sealing strip structure described in Embodiment 1 or the vehicle door described in Embodiment 2. In the embodiment of the subject application, by adding a second sealing part 12 for filling the gap space between the glass piece 2 and the cover plate 3 on a side of the sealing strip body 1 facing the glass piece 2, compared to the prior art, the first sealing part 11 and the second sealing part 12 in the structure form two defensive lines for sealing and water-blocking, ensuring that even if the added second sealing part 12 fails, the first sealing part 11 will still serve as the second defensive line, thus provide better sealing and waterproofing function, ensuring that even when the amount of water is large, water will not easily enter into the vehicle through the glass piece 2 to form water leakage. At the same time, the gap space between the glass piece 2 and the cover plate 3 is filled through the second sealing part 12, which can effectively reduce the amount of water entering between the glass piece 2 and the cover plate 3, thereby effectively avoiding the excessive water amount that causes water to cross the glass piece 2 and enter into the vehicle and form water leakage.

Obviously, the above-mentioned embodiments are only examples for clear explanation and are not intended to limit the implementation. For those skilled in the art, other different forms of changes or modifications can be made based on the above description. An exhaustive list of all implementations is not necessary or possible. The obvious changes or modifications derived therefrom are still within the protection scope of subject application.

1. A frameless vehicle door sealing strip structure, characterized in that, the frameless vehicle door sealing strip structure is used to sealingly connect a glass piece (2) and a cover plate (3), the frameless vehicle door sealing strip structure includes:
a sealing strip body (1) to be arranged between the glass piece (2) and the cover plate (3), the sealing strip body (1) is fixedly connected to a spigot component of side walls (31);
a first sealing part (11) arranged on a side, facing the glass piece (2), of the sealing strip body (1) in a protruding mode, and the first sealing part (11) attached to, the side of the sealing strip body (1) and abutting against the glass piece (2);
a second sealing part (12) arranged on the side, facing the glass piece (2), of the sealing strip body (1) in a protruding mode, and the second sealing part (12) is used for filling in a gap space between the glass piece (2) and the cover plate (3); and
a third sealing part (13) arranged on the side, facing the glass piece (2), of the sealing strip body (1) in a protruding mode, and the third sealing part (13) located between the first sealing part (11) and the second sealing part (12), and the third sealing part (13) attached to the side of the sealing strip body (1), and abutting against the glass piece (2).

2. The frameless vehicle door sealing strip structure according to claim 1, wherein the portion of the sealing strip body (1) between the third sealing part (13) and the second sealing part (12) is configured as a first arc segment (14), and wherein the second sealing part (12), the first arc segment (14) and the third sealing part (13) form a first water guide groove (15).

3. The frameless vehicle door sealing strip structure according to claim 1, wherein the portion of the sealing strip body (1) between the first sealing part (11) and the third sealing part (13) is configured as a second arc segment (16), and wherein the first sealing part (11), the second arc segment (16) and the third sealing part (13) form a second water guide groove (17).

4. The frameless vehicle door sealing strip structure according to claim 1, wherein the third sealing part (13) is configured as a third sealing lip distributed gradually away from the center of the circle in a circumferential direction.

5. The frameless vehicle door sealing strip structure according to claim 1, wherein the second sealing part (12) includes an arc surface (121) distributed gradually approaching the center of the circle in a circumferential direction, the arc surface (121) abuts against and is attached to the side, facing the cover plate (3), of the glass piece (2).

6. The frameless vehicle door sealing strip structure according to claim 1, wherein the first sealing part (11) is configured as a first sealing lip distributed gradually away from the center of the circle in the circumferential direction.

7. The frameless vehicle door sealing strip structure according to claim 1, wherein a side of the sealing strip body (1) facing away from the glass piece (2) is provided with an L-shaped hooking part (18), and the L-shaped hooking part (18) is provided with an installation groove (181) for the side walls (31) of the cover plate (3) to be embedded; a portion of the L-shaped hooking part (18) parallel to the glass piece (2) is provided a plurality of deformable first latching teeth (182) on a side of the portion facing the glass piece (2), and the first latching teeth (182) are used to snap into the first latching holes of the side walls (31) of the cover plate (3).

8-9. (canceled)

10. The frameless vehicle door sealing strip structure according to claim 2, wherein the second sealing part (12) includes an arc surface (121) distributed gradually approaching the center of the circle in a circumferential direction, the arc surface (121) is attached to the side, facing the cover plate (3), of the glass piece (2).

11. The frameless vehicle door sealing strip structure according to claim 3, wherein the second sealing part (12) includes an arc surface (121) distributed gradually approaching the center of the circle in a circumferential direction, the arc surface (121) is attached to the side, facing the cover plate (3), of the glass piece (2).

12. The frameless vehicle door sealing strip structure according to claim 4, wherein the second sealing part (12) includes an arc surface (121) distributed gradually approaching the center of the circle in a circumferential direction, the arc surface (121) is attached to the side, facing the cover plate (3), of the glass piece (2).

13. The frameless vehicle door sealing strip structure according to claim 2, wherein the first sealing part (11) is configured as a first sealing lip distributed gradually away from the center of the circle in the circumferential direction.

14. The frameless vehicle door sealing strip structure according to claim 3, wherein the first sealing part (11) is configured as a first sealing lip distributed gradually away from the center of the circle in the circumferential direction.

15. The frameless vehicle door sealing strip structure according to claim 4, wherein the first sealing part (11) is configured as a first sealing lip distributed gradually away from the center of the circle in the circumferential direction.
